(19) United States
(12) Patent Application Publication
(10) Pub. No.: US 2008/0173296 A1
(43) Pub. Date: Jul. 24, 2008

(54) HEATING COOKER AND METHOD OF CONTROLLING THE SAME

(76) Inventors: Dae Rae Lee, Gimhae-si (KR); Jung Wan Ryu, Changwon-si (KR); Dae Bong Yang, Jinhae-si (KR); Sang Min Lyu, Changwon-si (KR); Yong Ki Jeong, Busan (KR); Young Soo Kim, Changwon-si (KR)

Correspondence Address: BIRCH STEWART KOLASCH & BIRCH, PO BOX 747, FALLS CHURCH, VA, 22040-0747, US

(21) Appl. No.: 11/927,319

(22) Filed: Oct. 29, 2007

(30) Foreign Application Priority Data
Jan. 23, 2007 (KR) 10-2007-0007199
Jan. 24, 2007 (KR) 10-2007-0007356

(51) Int. Cl. F24C 3/12; G08B 21/00

(52) U.S. Cl. 126/42; 116/101; 126/1 R; 431/12

(57) ABSTRACT

An implementation of a heating cooker includes a case; a plate covering a top of the case; a plurality of burner systems provided in an internal space defined by the plate and the case; at least one switch controlling an on/off operation of the burner system; a temperature sensor detecting a temperature of the burner system and on-off-operated; and an alarming unit that generates an alarming signal according to at least one of on-operation of the switch and temperature value detected by the temperature sensor.

### CROSS-REFERENCE TO RELATED APPLICATIONS

The present invention claims priority under 35 U.S.C. 119 and 35 U.S.C. 365 to Korean Patent Application No. 10-2007-0007199 (filed on Jan. 23, 2007), which is hereby incorporated by reference in its entirety.

### BACKGROUND

This document relates to a heating cooker and a method of controlling the same.

A heating cooker is a kitchen appliance that can heat and cook food so that it is made edible.

The heating cookers are classified into an electric cooker that uses electric power to generate heat and a gas cooker that uses gas to generate the heat.

The gas cooker cooks the food by heating a container containing the food using the heat generated by combustion of mixture of gas and air.

Therefore, the gas cooker includes a combustion unit. The combustion unit mixes the gas with the air and combusts the mixture of the gas and air. That is, when the gas is injected in an internal space, the injected gas is introduced into the combustion unit together with ambient air.

The gas and air introduced into the combustion unit are uniformly mixed with each other and ignited so that the gas is combusted. The heat generated by the combustion of the gas is radiated and conducted to heat and cook the food.

### SUMMARY

Implementation of a heating cooker includes a case; a plate covering a top of the case; a plurality of burner systems provided in an internal space defined by the plate and the case; at least one switch controlling an on/off operation of the burner system; a temperature sensor detecting a temperature of the burner system and on-off-operated; and an alarming unit that generates an alarming signal according to at least one of on-operation of the switch and temperature value detected by the temperature sensor.

In another aspect of the present disclosure, implementation of a heating cooker includes at least one burner system heating food; a manipulation unit turning on/off the burning system; a temperature detecting unit detecting a temperature of the burner system and generating an on/off signal; and an alarming unit that generates an alarming signal with respect to at least one of an on-operations of the manipulation unit and the temperature sensor.

In still another aspect of the present disclosure, implementation of a heating cooker includes a case; a plate covering a top of the case; at least one burner system received in the case; at least one manipulation unit manipulating an on/off operation of the burner system; a thermostat that generates an on/off signal by detecting a temperature of the burner system; and at least one lamp that is turned on when one of the manipulation of the manipulation unit and the on-signal of the thermostat is detected.

In still yet another aspect of the present disclosure, implementation of a method of controlling a heating cooker includes operating at least one of burner systems through a manipulating operation; performing a first sequence in an alarming unit to let a user know that the burner system is operating; and performing, when the burner system reaches a predetermined temperature, a second sequence in the alarming unit to let the user know the operation state of the burner system.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view of a heating cooker according to an embodiment.

FIG. 2 is an exploded perspective view of the heating cooker of FIG. 1.

FIG. 3 is an exploded perspective view of the heating cooker of FIGS. 1 and 2, when a ceramic plate is removed.

FIG. 4 is a partial top plane view of the heating cooker of FIG. 1.

FIG. 5 is a partial top plane view of a heating cooker according to another embodiment.

FIG. 6 is a block diagram illustrating an operation of a heating cooker of the present disclosure.

### DETAILED DESCRIPTION OF THE EMBODIMENTS

Reference will now be made in detail to the embodiments of the present disclosure, examples of which are illustrated in the accompanying drawings.

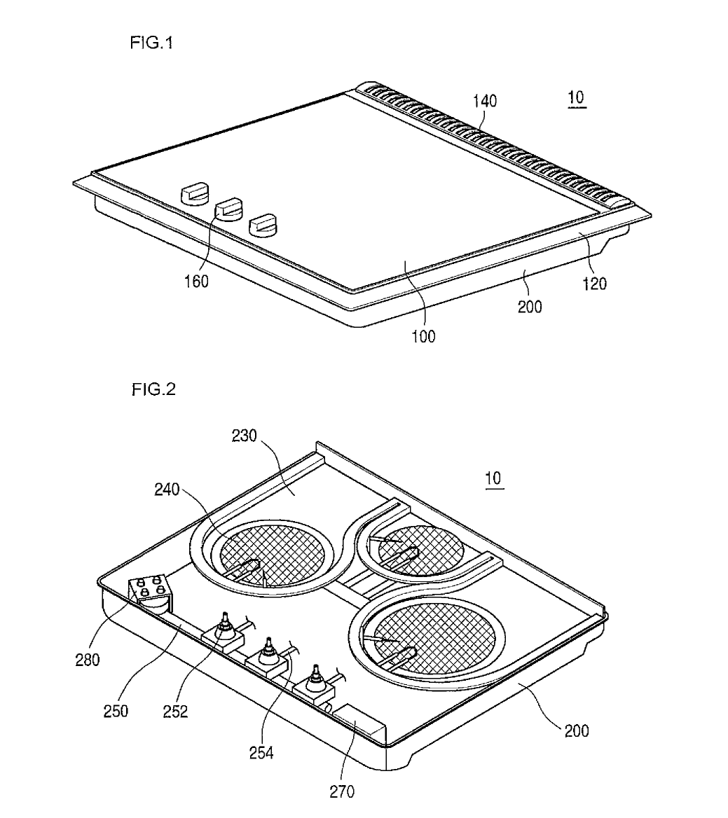

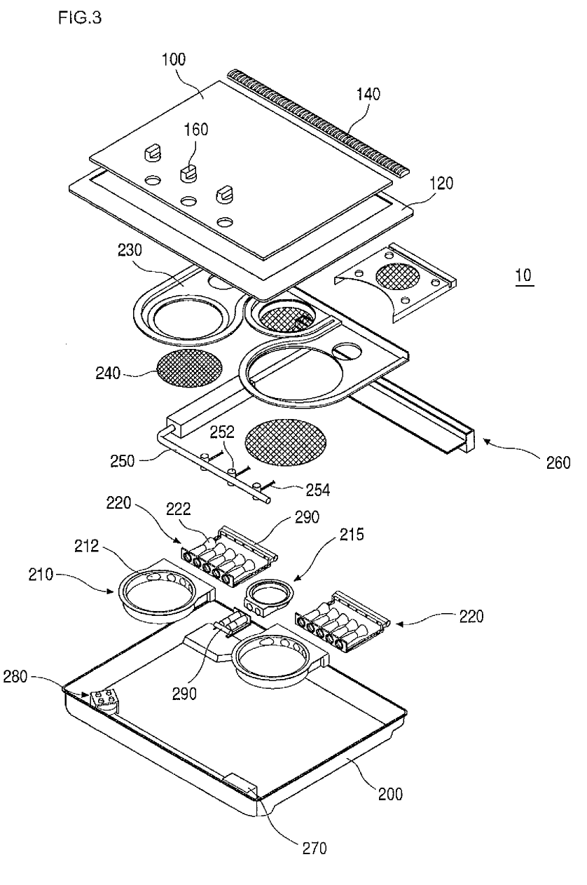

FIG. 1 is a perspective view of a heating cooker according to an embodiment, FIG. 2 is an exploded perspective view of the heating cooker of FIG. 1, and FIG. 3 is an exploded perspective view of the heating cooker of FIGS. 1 and 2, when a ceramic plate is removed.

Referring to FIGS. 1 through 3, a heating cooker according to an embodiment includes a case 200 protecting a lower portion of the cooker, defining an outer appearance of the cooker, and having an opened top, a ceramic plate 100 covering the opened top of the case 200 and supporting a container containing food, and a top frame 120 covering an edge of the ceramic plate 100.

The heating cooker further includes an exhaust grill 140, which is formed on a rear end of the ceramic plate 100 and through which combusted gas is exhausted, and control switches 160 that are provided on approximately a front portion of the ceramic plate to control an on/off of the combustion of the gas. The disposition location and shape of the exhaust grill 140 and the control switch 160 may vary. However, the exhaust grill 140 and the control switch 160 are essentially provided to exhaust the combusted gas and control the on/off of the combustion of the gas.

A plurality of components for combusting and exhausting the gas are received in an internal space defined by the ceramic plate 100 and the case 200. The following will describe the internal structure of the heating cooker.

A plurality of burner pots each providing spaces in which the gas and air are sufficiently mixed with each other and thus the uniform combustion can be realized are provide in the internal space. A mixing pipe unit 220 is disposed at a side of each of the burner pots 210 to supply the gas and air through the side of the burner pot 210.

A nozzle unit 290 is disposed to be spaced apart from inlets of the mixing pipe unit 22 by a predetermined distance so that the gas is injected toward the inlets of the mixing pipe unit 220 under high pressure.

A burner frame 230 is disposed above the burner pots 210. The burner frame 230 supports positions of the burner pots 210 and provides an exhaust passage of gas that is generated from a glow plate 240 that will be described later. An exhaust unit 260 for exhausting the combusted gas to an external side in rear of the burner frame. An exhaust grill 140 is disposed above the exhaust unit 260.

A top of the burner pot 210 is opened and the glow plate 240 is disposed on the opened top of the burner pot 210. The glow plate 240 is heated by combustion heat generated when the mixture of the gas and air is combusted. When the glow plate 240 is heated, radiant energy having a bandwidth corresponding to a physical property of the glow plate 240 is radiated.

The radiant energy of the glow plate 240 includes at least a frequency of a visible light bandwidth. Therefore, the user can be aware of the fact that the heating cooker is operating. Needless to say, the food is heated and cooked by the radiant heat generated from the glow plate 240 and the conductive heat transmitted from the glow plate 240 to the ceramic plate 100.

The following will describe a gas supply structure to the heating cooker.

The gas is directed from the external side into the heating cooker through a main supply pipe 250. The gas supply direction to each of burner systems is controlled by a gas valve 252 operated by the manipulation switch 160. The gas passing through the gas valves 252 is directed to the nozzle units 290 through gas supply pipes 254 connected to the respective burner systems.

The gas directed to the nozzle units 290 is injected to the inlets of the mixture piper units 220 under high pressure. At this point, since the gas is injected at a high speed toward the inlet of the mixing pipe units 220, a lower pressure atmosphere is formed at a space near the inlets of each mixing pipe unit 220 in accordance with Bernoulli's principle.

Therefore, the external air is also introduced into the mixing pipe units 220 and a mixture is formed while the gas and air passing through the mixing pipe unit 220 are mixed with each other. The gas and air are introduced into internal spaces of the burner pots 210 and further mixed with each other. This mixture of the gas and air is combusted in each of the glow plates 240.

Each of the glow plate 240 is provided in the form of a net having a plurality of fine holes. The mixture of the gas and air is combusted while passing through the holes. The combusted gas generated by the combustion of the mixture is directed to the exhaust grill 140 along the exhaust passage provided by the burner frame 230 and exhausted to the external side. Therefore, the exhaust passage may be a space defined between a bottom of the ceramic plate and a top of the burner frame 230.

Meanwhile, the burner pots 210 having different calorific values are disposed in the internal space of the case 200 and one of the burner pots 210 is selected in accordance with a kind of the food. By disposing the container containing the food that will be cooked on a portion of the ceramic plate 100, which corresponds to the selected burner pot 210, the user's convenience can be maximized.

In more detail, two relatively large-sized burner pots 210 are disposed at both sides of the internal space of the case 20 and one relatively small-sized burner pot 210 is disposed between the two relatively large-sized burner pots 210. For the small-sized burner pot 210, the gas and air are supplied from the front side to the rear side of the heating cooker and the gas and air are further perfectly mixed with each other. The mixture of the gas and air is combusted in the glow plate 240 and exhausted toward the exhaust unit 260.

For the large-sized burner pots 210 that are disposed at the both sides of the internal space of the case 200, the gas and air are supplied from the rear side to the front side of the heating cooker. After the gas and air are further mixed with each other in the burner pots 210, the mixture of the gas and air is combusted in the glow plates 240 and exhausted rearward of the burner pots 210.

As described above, the disposition of the burner pots 210 is for realizing an optimum heating burner system.

According to the burner system of the heating cooker of the embodiment, a height of the burner pot is lowered, an amount of the air relative to an amount of the gas (hereinafter, referred to as “air ratio”) increases, and a flow resistance of the mixture of the gas and air can be reduced.

The following will describe a structure of the burner system of the heating cooker of the embodiment.

The burner pots 210 are provided in the internal space of the case 200. The mixing pipe unit 220 is disposed at a side surface of each of the burner pots 210. Each of the nozzle unit 290 is disposed adjacent to the inlet of each of the mixing pipe unit 220.

Here, the mixing pipe unit 220 is aligned with openings 212 formed on the side surface of the burner pot 210. A plurality of mixture pipes 222 of the mixing pipe unit 220 are aligned with the openings 212. Therefore, an amount of the air introduced together with the gas can be maximized. The alignment of the mixing pipe unit 220 with the openings 212 will be described in more detail later.

The height of each of the openings 212 is equal to or slightly less than that of the burner potion 210. That is, the openings 212 are formed in a circular shape when viewed in an extending direction of the mixture pipe tube 222. A diameter 212 of the opening 212 is substantially identical to a vertical height of the space where the gas and air can be sufficiently mixed with each other so that the mixture of the gas and air that are fully mixed with each other can be diffused into the burner pot 210.

Since the height of each of the openings 212 is substantially identical to that of the burner pot 210 as described above, the diffusion of the mixture can be enhanced in the burner pot 210 and the height of the burner pot 210 can be reduced to the maximum.

Further, each of the mixture pipes 222 has a nozzle portion whose sectional area is gradually reduced from the inlet and a diffuser portion extending from the nozzle portion and having a sectional area that is gradually increased from the nozzle portion.

The increase of the sectional area of the diffuser portion of the mixture pipe 222 is in repose to the area of the opening 212 for the continuity, thereby reducing the flow resistance of the fluid.

Therefore, the diffusion angle of the mixture pipe 222 of the opening 212 corresponds to the diameter of the opening 212. That is, an extending line from the diffuser portion of the mixture pipe 222 may meet the circumference of the opening 212.

Meanwhile, as described above, the mixing pipe unit 220 is coupled to one side of the burner pot 210. In more detail, the mixing pipe unit 220 has a plurality of the mixture pipes 222 and the burner pot 210 has a plurality of the openings 212 aligned with the mixture pipes 222. The nozzle unit 290 is disposed near the inlets of the mixing pipe unit 220.

The nozzle unit 290 is formed in a straight pattern since the mixing pipe unit 220 is generally arranged in a straight pattern. Therefore, the arrangement of the burner system can be realized in the more compact structure.

Since the mixing pipe unit 220 has the mixture pipes 222 that are horizontally arranged in parallel with each other, an amount of the air introduced together with the gas injected from the nozzle unit 290, i.e., the air ratio, can be increased. In more detail, as the plurality of the mixture pipes 222 are provided, a large amount of the air can be introduced through the mixture pipes 222 together with the gas.

That is, it can be understood that an amount of the air introduced is greater than a case where the air is introduced through a single mixture pipe is used. For example, when the gas is introduced through the single mixture pipe 222, a lower pressure atmosphere is formed around the single mixture pipe 222 and thus the air is introduced through the single mixture pipe 222. However, when the gas is introduced through the plurality of the mixture pipes 222, an overall space through which the air is introduced is increased. Accordingly, a total amount of the air introduced through the plurality of the mixture pipes 222 is greater than an amount of the air introduced through the single mixture pipe.

Further, the mixture pipes 222 are arranged in parallel with each other at an almost identical horizontal level. Although the mixture pipes 222 may be arranged at different horizontal levels, the level difference is limited within a predetermined range.

As described above, since the mixture pipes 222 are arranged in parallel with each other, the mixture gas introduced into the burner pot 210 collides each other to generate a turbulent flow. This increases the mixing of the gas and air and thus improves the combustion efficiency. Here, the reason for limiting the range within which the horizontal levels of the mixture pipes 222 may be different from each other is that the height where the mixture pipes 222 can be disposed is limited within a range within which the openings 212 can be formed.

Meanwhile, the mixture pipes 222 may extend in an identical direction. That is, extending lines of the mixture pipes 222 may not meet each other. This increases the generation of the turbulent flow of the mixture discharged from the mixture pipes 220. In addition, a manufacturing process of the mixing pipe unit 220 is simplified and the nozzle unit 290 aligned with the mixing pipe unit 220 can be easily mounted.

Further, as shown in the drawings, the number of the mixture pipes 222 of the mixing pipe unit 220 is five. This is determined through many tests. According to the tests, as the number of the mixture pipes 222 increases from one to five, an increase rate of the air ratio steeply increases. However, when the number of the mixture pipes 222 is more than five, the increase rate is steeply reduced. Since the efficiency of the air ratio slightly increases as compared with the costs for manufacturing one mixture pipe 222. Therefore, it is desirable that the number of the mixture pipes is five.

A range where the mixture pipes 222 are arranged is equally divided at the side surface of the burner pot 210. One of the mixture pipes 222, which is disposed at an end may be disposed at an end of a diameter of the burner pot 210 to improve the mixing efficiency of the gas and air that are introduced into the burner pot 210 by effectively generating the turbulent flow in the internal space of the burner pot 210.

According to the flows of the mixture of the gas and air in different directions along tangent lines in an inner surface of the burner pot 210, locations where the mixtures collide with each other are formed, thereby generating the turbulent flow by which the mixture of the gas and air is generally diffused in the burner pot 210. As a result, it can be understood that the gas and air are uniformly mixed with each other in the burner pot 210.

As described above, by uniformly mixing the gas and air with each other in the burner pot 210, the generation of the mixture of the air and gas and the uniform combustion performance can be realized even when the height of the burner pot 210 is lowered.

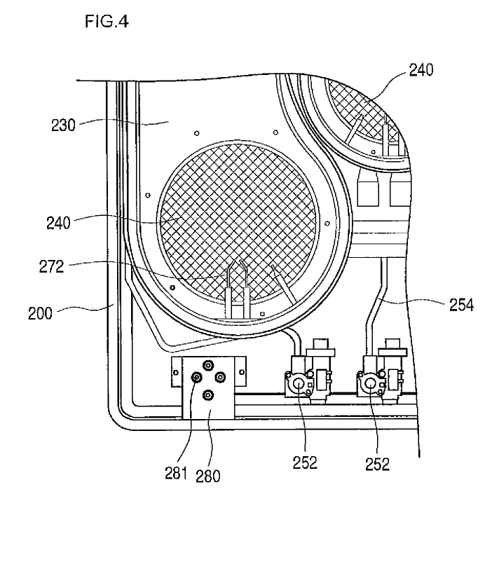

The following will describe components for controlling the burner system with reference to FIGS. 4 and 5.

A plurality of control components for controlling the burner system are mounted on a front portion of the internal space of the case 200. The gas valves 252 operated by the manipulation switches 160 are disposed in a space where the control components are mounted. When the user manipulates the manipulation switch 160, an amount of the gas supplied to the burner system through the main supply pipe 250 is adjusted by the gas valve 252.

An ignition transformer 270 for supplying a current generating a flame igniting the gas supplied into the internal space of the burner frame is disposed at a side of the gas valve 252.

An ignition plug 272 generating the flame using the current supplied from the ignition transformer 270 is located to be spaced apart from the top of the glow plate 240 by a predetermined distance. Therefore, the mixture of the gas and air that passes the glow plate 240 is ignited by the ignition flame generated by the ignition plug 272 and combusted on the glow plate 240. Therefore, the glow plate 240 radiates the radiant energy.

The burner system includes a temperature sensor for detecting a temperature of the burner system. When the detected temperature is equal to or greater than a predetermined value, the temperature sensor is turned on. When the detected temperature of the burner system is less than the predetermined value, the temperature sensor is turned off. A thermostat that can automatically control the temperature may be used as the temperature sensor.

The thermostat is designed to be turned on when the temperature is higher than a reference value and be turned off when the temperature is less than the reference value. A bimetal is used for the thermostat to perform the on/off operation. The bimetal is formed by attaching two metal plates having different coefficients of thermal expansion. When the temperature reaches the predetermined value by the different coefficients of the thermal expansion of the two metal plates, the metal plate having the higher coefficient of the thermal expansion further expands and a degree of bending varies, by which the thermostat performs the on/off operation.

A detailed structure of the thermostat will be omitted herein.

The thermostat may be disposed any portion of the burner system. However, it may be desirable that the thermostat is disposed near the burner pot 210 so as to effectively detect the temperature of the burner system.

Meanwhile, an alarming unit 280 is provided at a side opposite to the ignition transformer 270. That is, the alarming unit 280 lets the user know if the heating cooker is being used or not or if the temperature of the burner system is greater or less than a predetermined value.

When either the manipulation switch 160 is turned on or the temperature sensor is turned on, the alarming unit 280 generates an alarming signal.

To realize the above, a signal transmission unit such as a micro switch is provided on the gas valve 252 to transmit a signal to the alarming unit 280 when the manipulation switch 160 is manipulated. In more detail, when the user rotates the manipulation switch 160 to operate the heating cooker, the signal transmission unit such as the micro switch generates the signal by the rotation of the manipulation switch 160 and transmits the signal to the alarming unit 280.

The alarming unit 280 includes a plurality of lamps 281 so that the user can identity the current state of the heating cooker. The lamps 281 are disposed on the front portion of the inner space of the case 200 and covered by the ceramic plate 100. As described above, when the temperature of the burner system is equal to or greater than the predetermined value, the alarming unit 280 turns on the lamps 281 so that the user can identify the current state of the heating cooker. That is, when the burner system operates by the manipulation of the manipulation switch 160, the lamps 281 of the alarming unit 280 are turned on so that the user can identify the operation of the burner system.

The lamps 281 of the alarming unit 280 are designed such that light emitted from them can pass through the ceramic plate 100. Further, the number of the lamps 281 is identical to or greater than the number of the burner systems provided in the case 200. That is, the lamps 281 are provided to correspond to the respective burner systems. Therefore, when one of the burner systems operates or the temperature of one of the burner systems is equal to or greater than the predetermined value, the corresponding lamp 281 is turned on.

Needless to say, the lamps 281 of the alarming unit 280 may emit a variety of colors of light. At this point, a color of the light emitted from the lamp when the manipulation switch 160 is manipulated may be different from that of the light emitted from the lamp when the temperature is equal to or greater than the predetermined value. In this case, the user can more accurately identify the current state of the heating cooker.

For example, when the manipulation switch is manipulated, a blue light may be emitted, and a red light may be emitted when the temperature is determined to rise beyond a reference temperature. Also, by emitting a lamp when the manipulation switch 160 is manipulated and sounding an alarm when the temperature is detected to be higher than a reference temperature, a user may be accurately alerted.

According to another aspect of the heating cooker of this embodiment, the heating cooker includes at least one burner system and a manipulation switch 160 by use of which the user can turn on or off the burner system. The heating cooker further includes a temperature detecting sensor generating an on/off signal by detecting the temperature of the burner system and an alarming unit for generating an alarming signal in response to at least one of an on-signal of the temperature detecting unit and an on-operation of the manipulation switch 160.

Therefore, when at least one of the on-signal of the temperature detecting unit and the on-operation of the manipulation switch 160 is detected, the alarming unit 280 generates an alarming signal. To this end, the temperature detecting unit is disposed above the glow plate 240 at a predetermined interval to detect a temperature of a portion having the highest temperature in the burner system by the combustion heat generated when the gas is combusted.

By detecting the temperature of the portion having the highest temperature, it can be prevented that the user is injured by other portions.

That is, in the burner system of this embodiment, the gas is combusted on the glow plate 240. Therefore, the temperature detecting unit is disposed above the glow plate 240 heated at the highest temperature of the combustion of the gas and radiating the radiant heat.

Therefore, a portion where the temperature detecting unit is located is a portion having the highest temperature. As described above, by detecting the temperature of the portion having the highest temperature and letting the user know this, the injury of the user by other portions can be prevented.

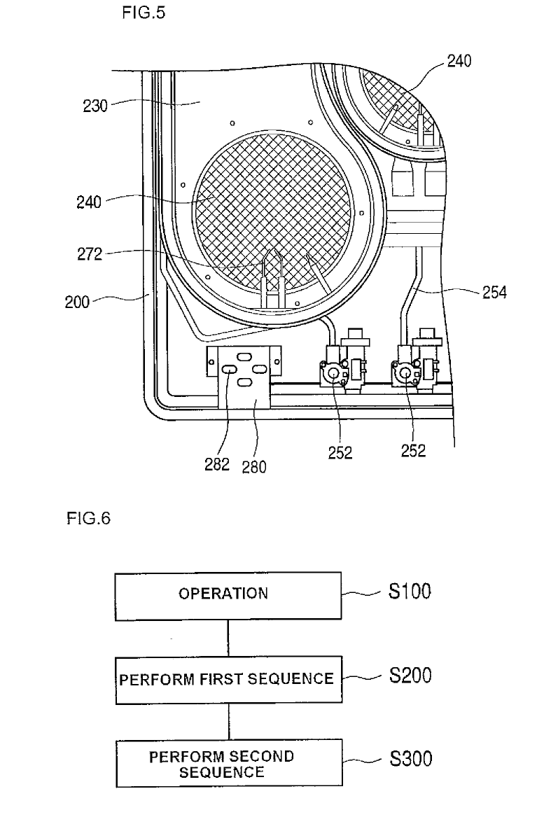

Meanwhile, a method of controlling the heating cooker according to an embodiment of the present disclosure will be described with reference to FIG. 6.

At least one of the burner systems of the heating cooker (S100). When the operation of the burner system is detected, a first sequence is performed in the alarming unit 280 to let the user know the operation of the burner system (S200).

In the step S100, when the temperature of the burner system reaches a predetermined value, the alarming unit 280 performs a second sequence to transmit the fact that the burner system is operating to the user (S300).

Here, the operation of the heating cooker may be done in accordance with the user's intension or regardless of the user's intension. Further, the operation of the heating cooker may be done by other external causes. For example, the operation of the heating cooker may be done by curiosity of a children or carelessness of the user.

In any cases, when the manipulation switch 160 is manipulated, the first sequence is performed in the alarming unit 280. When the first sequence is performed, electric power is applied to a light emission unit 282 formed in the alarming unit 280 so that the light emission unit 282 emits the light to the external side.

Therefore, the first sequence includes a process for applying the electric power to the light emission unit 282 and a process for emitting the light from the light emission unit 282 to the external side.

When the burner system operates by the user manipulating the manipulation switch 160 and the temperature of the burner system reaches the predetermined value, the second sequence is performed in the alarming unit 280 to transmit a signal letting the user know that the burner system is operating. The second sequence is identically performed to the first sequence.

Further, the number of the light emission units 282 is identical to or greater than the number of the burner systems provided in the case 200. Therefore, when one of the burner systems operates to generate a signal, the corresponding light emission unit 282 is turned on so as to let the user know a current operation state of the burner system.

The first and second sequences are individually performed when the light emission unit 282 corresponding to the burner system. That is, when one of the burner systems, which has a relative large calorific energy, operated, the first and second sequences are individually performed in the light emission unit 282 corresponding to the operating burner system.

Meanwhile, according to another aspect of the heating cooker of the present disclosure, the lamps 281 of the alarming unit 280 are light emitting diodes. The light emission diode is designed to emit light by rejoining of electrons and holes using a joining structure of a semiconductor. Since the light emission diode is relatively small, has a long lasting service life, and coverts electric energy into light energy directly, the power consumption is reduced and the quick response speed can be obtained.

The present disclosure is not limited to the above-described embodiments.

For example, the temperature sensor may not be located above the glow plate 240 but at a side of the burner frame 230. Further, a sound generation unit may be provided to generate an alarming source. Therefore, the alarming signal may be transmitted to the user by the sound and light.

Furthermore, any other alarming structure that can allow the user to identify the current operation state may be used.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

Implementation of the heating cooker can increase the combustion efficiency of the gas in the burner system and reduce the flow resistance of the gas and air.

Further, the air ratio increases by the introduced mixture of the gas and air.

In addition, since an overall size of the heating cooker, particularly, a height of the burner system is reduced, the installation and using convenience can be enhanced and the manufacturing cost can be reduced.

Furthermore, when there is an error in any one of the temperature sensor detecting the temperature of the burner system and the manipulation switch controlling the on/off operation of the burner system providing heat for cooking food, an alarming signal is generated so that the user can more safely use the heating cooker.

In addition, since the alarming signal is generated by the manipulation of the manipulation switch and the temperature sensor, if there is an error in one of them, the alarming signal can be still generated. Therefore, the injury of the user can be prevented.

What is claimed is:

1. A heating cooker comprising:
a case;
a plate covering a top of the case;
a plurality of burner systems provided in an internal space defined by the plate and the case;
at least one switch controlling an on/off operation of the burner system;
a temperature sensor detecting a temperature of the burner system and on-off-operated; and
an alarming unit that generates an alarming signal according to at least one of on-operation of the switch and temperature value detected by the temperature sensor.

2. The heating cooker according to claim 1, wherein the alarming unit includes a lamp.

3. The heating cooker according to claim 2, wherein the lamp is located under the plate.

4. The heating cooker according to claim 1, wherein the number of the alarming unit is the same as or more than the number of the burner system.

5. The heating cooker according to claim 1,
wherein the alarming unit generates different alarming signals with respect to the on-operation of the burner system and the on-operation of the switch.

6. The heating cooker according to claim 1, wherein the burner system generates heat using a gas combustion manner.

7. The heating cooker according to claim 1, wherein the temperature sensor generates an on-signal when the temperature of the burner system is equal to or higher than a predetermined value and generates an off-signal when the temperature of the burner system is lower than the predetermined value.

8. A heating cooker comprising:
at least one burner system heating food;
a manipulation unit turning on/off the burning system;
a temperature detecting unit detecting a temperature of the burner system and generating an on/off signal; and
an alarming unit that generates an alarming signal with respect to at least one of an on-operations of the manipulation unit and the temperature sensor.

9. The heating cooker according to claim 8, wherein the burner system comprises:
a nozzle unit injecting gas;
a mixing pipe unit that is disposed in front of the nozzle unit to mix the gas with air;
a burner pot that is disposed in front of the mixing pipe unit to further mix the gas with the air; and
a glow plate that is disposed above the burner pot to generate radiant energy.

10. The heating cooker according to claim 9, wherein the temperature detecting unit is disposed above the glow plate.

11. A method of controlling a heating cooker, comprising:
operating at least one of burner systems through a manipulating operation;
performing a first sequence in an alarming unit to let a user know that the burner system is operating; and
performing, when the burner system reaches a predetermined temperature, a second sequence in the alarming unit to let the user know the operation state of the burner system.

12. The method according to claim 11, wherein the alarming unit includes a light emission unit emitting light.

13. The method according to claim 12, wherein the first or second sequence comprises:
applying electric power to the light emission unit; and
allowing the light emission unit to emit light to an external side.

14. The method according to claim 11, wherein the first sequence is identically performed to the second sequence.

15. The method according to claim 11, wherein the burner system is operated using a gas combustion manner.

16. The method according to claim 11, wherein the alarming unit includes a plurality of light emission units, the number of which is identical to the number of the burner systems.

17. The method according to claim 16, wherein the burner system performs individual sequences when the alarming unit operates.

18. A heating cooker comprising:
a case;
a plate covering a top of the case;
at least one burner system received in the case;
at least one manipulation unit manipulating an on/off operation of the burner system;
a thermostat that generates an on/off signal by detecting a temperature of the burner system; and
at least one lamp that is turned on when one of the manipulation of the manipulation unit and the on-signal of the thermostat is detected.

19. The heating cooker according to claim 18, wherein the lamp includes a light emitting diode.

20. The heating cooker according to claim 18, wherein the number of the lamps is identical to the number of the burner systems.
